(19) United States
(12) Patent Application Publication
(10) Pub. No.: US 2009/0127354 A1
(43) Pub. Date: May 21, 2009

(54) FUEL INJECTION VALVE

(75) Inventors: Noboru Matsusaka, Kariya-city (JP); Yoshitomo Oguma, Hekinan-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/264,278

(22) Filed: Nov. 4, 2008

(30) Foreign Application Priority Data
Nov. 20, 2007 (JP) 2007-300558

(51) Int. Cl. F02M 51/06

(52) U.S. Cl. 239/585.1

(57) ABSTRACT

A coil is located radially outside of a cylindrical pipe and configured to generate a magnetic field when being energized. A stationary core is located radially inside of the pipe. A moving core is located radially inside of the pipe and opposed to the stationary core. The moving core is configured to be attracted to the stationary core by magnetic attraction force generated therebetween. A valve element is axially movable together with the moving core to open and close a nozzle hole for injecting fuel. A housing surrounds both an outer circumferential periphery of the coil and one end of the coil in an axial direction. A cover surrounding an other end of the coil in the axial direction. The pipe and the housing are integrally formed and one component.

### CROSS REFERENCE TO RELATED APPLICATIONS

This application is based on and incorporates herein by reference Japanese Patent Application No. 2007-300558 filed on Nov. 20, 2007.

### FIELD OF THE INVENTION

The present invention relates to a fuel injection valve for an internal combustion engine.

### BACKGROUND OF THE INVENTION

For example, JP-A-2004-169568 discloses a fuel injection valve for an internal combustion engine. Conventionally, as shown in FIG. 8, a fuel injection valve (injector) 91 includes a pipe 911, a stationary core 920, a moving core 922, and a needle 940. The stationary core 920 is located around the inner circumferential periphery of the pipe 911. The moving core 922 is opposed to the stationary core 920 in the axial direction and configured to be drawn toward the stationary core 920 by exerted with magnetic attraction force generated between the stationary core 920 and the moving core 922. The needle 940 as a valve element is movable together with the moving core 922 in the axial direction and configured to open and close nozzle holes 934 to inject fuel. A coil 951 is provided around the outer circumferential periphery of the pipe 911 and configured to generate a magnetic field when being energized. A housing 912 surrounds both the outer circumferential periphery of the coil 951 and one axial end of the coil 951 in the axial direction, thereby supporting the coil 951. A cover 960 surrounds the other axial end of the coil 951 in the axial direction. That is, in the present structure shown in FIG. 8, the coil 951 is enclosed by the pipe 911, the housing 912, and the cover 960.

However, the fuel injection valve (injector) 91 of FIG. 8 has the following problems. The housing 912 needs to be mounted and fixed to the outer circumferential periphery of the pipe 911 by welding or the like. In addition, the pipe 911 needs to be aligned relative to the housing 912 in the axial direction when being mounted to the housing 912. Accordingly, productivity of the injector is impaired due to increase and complication in the assembling process and the like. Productivity of the injector is further impaired as components surrounding the coil 951 increases.

### SUMMARY OF THE INVENTION

In view of the foregoing and other problems, it is an object of the present invention to produce a fuel injection valve having a simple structure and excellent in productivity and quality.

According to one aspect of the present invention, a fuel injection valve comprises a pipe being substantially in a cylindrical shape. The fuel injection valve further comprises a coil located radially outside of the pipe and configured to generate a magnetic field when being energized. The fuel injection valve further comprises a stationary core located radially inside of the pipe. The fuel injection valve further comprises a moving core located radially inside of the pipe and opposed to the stationary core, the moving core configured to be attracted to the stationary core by magnetic attractive force generated between the moving core and the stationary core. The fuel injection valve further comprises a valve element movable together with the moving core in an axial direction and configured to open and close a nozzle hole for injecting fuel. The fuel injection valve further comprises a housing surrounding both an outer circumferential periphery of the coil and one end of the coil which is at one end side in the axial direction. The fuel injection valve further comprises a cover surrounding an other end of the coil, which is at an other end side in the axial direction. The pipe and the housing are integrally formed and a single component.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing an injector according to a first embodiment;

FIG. 2 is a sectional view showing a pipe member including a pipe and a housing of the injector according to the first embodiment;

FIG. 3 is a schematic view showing an injection molding of the pipe portion, according to the first embodiment;

FIG. 4A is a perspective view showing a jig for supporting a molded product of the pipe portion, and FIG. 4B is a schematic sectional view showing the molded product supported by the jig, according to the first embodiment;

FIG. 5 is a sectional view showing a pipe member according to a second embodiment;

FIG. 6A is a pipe member according to an example of the second embodiment; and FIG. 6B is a rear view showing the pipe member;

FIG. 7 is a graph showing a relationship between lateral force exerted to a pipe member and stress caused in the pipe member, according to a third embodiment; and

FIG. 8 is an injector according to a prior art.

### DETAILED DESCRIPTION OF PREFERRED EMBODIMENTS

### First Embodiment

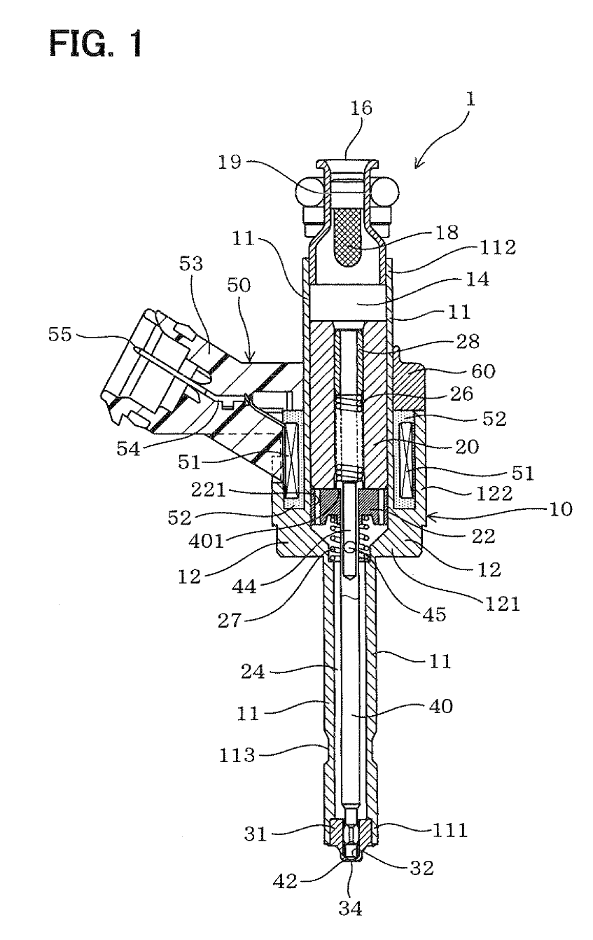

A fuel injection valve (injector) according to the present embodiment is described with reference to drawings. As shown in an FIG. 1, an injector 1 in the present embodiment is applied to a direct-injection gasoline engine. The application of the injector 1 is not limited to the direct-injection gasoline engine and may be applied to a premix gasoline engine or a diesel engine. The injector 1 is mounted to an engine head (not shown) when being applied the direct-injection gasoline engine. In the present embodiment, the injector 1 has a tip end side, to which nozzle holes 34 are provided, and a rear end side at the opposite side of the tip end side.

The injector 1 has a pipe 11, which is substantially in a cylindrical shape. The pipe 11 therein accommodates a stationary core 20. The stationary core 20 is substantially in a cylindrical shape. The pipe 11 has a rear end side farther than the stationary core 20, and the rear end side defines a fuel passage. The pipe 11 and the stationary core 20 are formed from a magnetic material such as electromagnetic stainless steel.

The pipe 11 has a rear end 112, to which an external connector 19 is press-fitted. The external connector 19 has a rear end defining a fuel inlet 16. The fuel inlet 16 is supplied with fuel by a fuel pump (not shown) from a fuel tank. The fuel supplied to the fuel inlet 16 flows into a fuel passage 14 after passing through a filter member 18, which is provided inside the external connector 19. The filter member 18 removes foreign matter contained in the fuel.

The pipe 11 has a tip end 111, which accommodates a valve body 31. The valve body 31 is substantially in a cylindrical shape, for example, and fixed to the tip end 111 of the pipe 11 by press-fitting, welding, or the like. The valve body 31 has an inner wall surface, which is substantially in a conical shape and reduces in the inner diameter toward the tip end thereof. The inner wall surface of the valve body 31 defines a valve seat 32. The nozzle holes 34 are provided in the tip end of the valve body 31. The nozzle holes 34 communicate the inside of the valve body 31 with the outside of the valve body 31. The nozzle holes 34 may be a single hole or multiple hoes.

The pipe 11 has a tip end farther than the stationary core 20, and the tip end accommodates a moving core 22 and a needle 40 as a valve element. The moving core 22 is axially movable at the radially inside of the pipe 11. The moving core 22 is substantially in a cylindrical shape and formed from a magnetic material such as electromagnetic stainless steel. The moving core 22 has a through hole 221, which extends substantially in the axial direction. The through hole 221 is configured to therethrough communicate fuel so as to restrict the moving core 22 from sticking the stationary core 20 when the moving core 22 is attracted to the stationary core 20. In the present structure, the needle 40 can be smoothly manipulated to open and close the nozzle holes.

The needle 40 is located radially inside of the pipe 11 and substantially coaxial with the valve body 31. The needle 40 has a tip end defining a seal portion 42. The seal portion 42 is configured to be seated to the valve seat 32 of the valve body 31. The needle 40 is substantially in a cylindrical shape and therein defines a fuel passage 44. Fuel flows from the fuel passage 44 inside the needle 40 into a fuel passage 24 outside the needle 40 through a fuel hole 45. The needle 40 has a rear end, which is fixed to the moving core 22. In the present structure, the moving core 22 and the needle 40 are integrally movable back and forth in the axial direction. The moving core 22 and the needle 40 may be separate components.

The needle 40 has a rear end, which is in contact with a first spring 26 as a biasing member. The first spring 26 has one end, which is in contact with the rear end of the needle 40. The first spring 26 has the other end, which is in contact with an adjusting pipe 28. The moving core 22 has a tip end, which is in contact with a second spring 27 as a biasing member. Each of the biasing members is not limited to the spring and may be a blade spring, a gas damper, a liquid damper, or the like.

The adjusting pipe 28 is press-inserted into the inner circumferential periphery of the stationary core 20. The load exerted from the first spring 26 is controlled by adjusting the press-fitted margin of the adjusting pipe 28. The first spring 26 is extendable in the axial direction. In the present structure, the needle 40 and the moving core 22 are integrally biased from the first spring 26 such that the seal portion 42 is seated to the valve seat 32. Simultaneously, the moving core 22 is biased from the second spring 27 such that the rear end of the moving core 22 makes contact with a contact portion 401 of the needle 40.

A coil assembly 50 is provided around the outer circumferential periphery of the pipe 11. The coil assembly 50 is integrally formed of a coil 51, a mold element 52, and an electrical connector 53. The coil 51 is covered with the mold element 52, which is formed of resin. The coil 51 is substantially in a cylindrical shape and has the outer circumferential periphery and the inner circumferential periphery both being covered with the mold element 52. The coil 51 surrounds throughout the outer circumferential periphery of the pipe 11 in the circumferential direction. The mold element 52 and the electrical connector 53 are integrally formed from resin. The coil 51 is connected with a terminal 55 of the electrical connector 53 via a wiring member 54.

The coil 51 has the outer circumferential periphery and the tip end both provided with a housing 12. The housing 12 has a housing bottom portion 121 and a housing outer end 122. The housing bottom portion 121 protrudes from the pipe 11 in the radial direction. The housing outer end 122 extends from the outer end of the housing bottom portion 121 in the axial direction. The housing 12 and the pipe 11 therebetween define a space, which accommodates the coil 51 covered with the mold element 52. The coil 51 has the rear end, which is provided with a cover 60. The cover 60 surrounds the rear end of the coil 51. The housing 12 and the cover 60 are formed from a magnetic material such as electromagnetic stainless steel. The pipe 11 and the housing 12 are integrally formed with the housing bottom portion 121 to define a bottomed double-pipe structure.

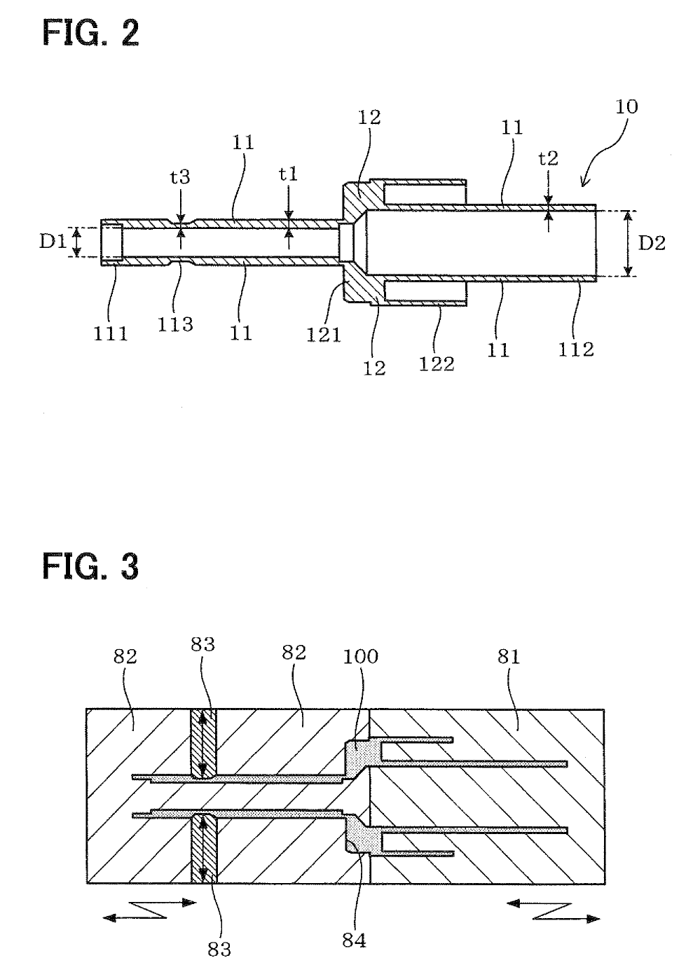

As shown in FIGS. 1, 2, in the present embodiment, the pipe 11 and the housing 12 of the injector 1 do not have a joined portion therebetween. That is, the pipe 11 and the housing 12 are integrated to be a pipe member 10 as one component (single component). The pipe member 10 includes a double pipe portion. According to the present embodiment, the pipe member 10 is integrally formed by metal injection molding (MIM).

As shown in FIG. 2, the tip end as a valve-accommodating portion of the pipe 11 of the pipe member 10 accommodates the needle 40 and has the inner diameter of D1. The rear end as a moving-core-accommodating portion of the pipe 11 accommodates the moving core 22 and has the inner diameter of D2. The inner diameters D1, D2 suffice the relationship of D1≦D2. In the present embodiment the inner diameter D1 satisfies D1=φ4.7 mm, and the inner diameter D2 satisfies D2=φ0.6 mm.

The tip end of the pipe 11 is dented in the radial direction to define a fitting portion 113 to be fitted with a sealing member (not shown), which is substantially in a ring shape. The sealing member is configured to seal between the injector 1 and the engine head when the injector 1 is mounted to the engine head. The fitting portion 113 has the thickness t3. The pipe 11 has an intermediate portion at the rear side of the fitting portion 113, and the intermediate portion has the thickness t1. The relationship between the thicknesses t3, t1 satisfies t1≧t3. In the present embodiment, the thickness t1 satisfies t1=1 mm, and the thickness t3 satisfies t3=0.7 mm. The thickness t2 of the rear-side portion of the pipe 11 is greater than or equal to 1 mm. In the present embodiment, the thickness t2 satisfies t2=1 mm. FIG. 2 depicts only the pipe member 10.

Next, an operation of the injector 1 is described. Referring to FIG. 1, when the coil 51 is de-energized, the stationary core 20 and the moving core 22 do not cause magnetic attraction force therebetween. In the present condition, the moving core 22 is biased by the first spring 26 and moved away from the stationary core 20. Consequently, when the coil 51 is de-energized, the seal portion 42 of the needle 40, which is integrated with the moving core 22, is seated to the valve seat 32 to be in a closed state. Therefore, fuel is not injected from the nozzle holes 34.

When the coil 51 is energized, the coil 51 generates a magnetic field to cause magnetic flux through a magnetic circuit defined in the housing 12, the pipe 11, the moving core 22, the stationary core 20, and the cover 60. Thus, the stationary core 20 and the moving core 22, which are apart from each other, generate magnetic attraction force therebetween. When the magnetic attraction force, which is generated between the stationary core 20 and the moving core 22, becomes greater than the biasing force of the first spring 26, the moving core 22 and the needle 40 integrally move toward the stationary core 20. Consequently, the seal portion 42 of the needle 40 is lifted from the valve seat 32 to be in an opened state.

Fuel flows into the fuel inlet 16 and passes through the filter member 18, the fuel passage 14 inside the pipe 11, the passage inside the adjusting pipe 28 and the stationary core 20, and the fuel passage 44 inside the needle 40. The fuel flows into the fuel passage 24 outside the needle 40 through the fuel hole 45. The fuel flowing into the fuel passage 24 passes through the gap between the valve body 31 and the needle 40, which is lifted from the valve seat 32, and the fuel is injected from the nozzle holes 34.

When the coil 51 is de-energized, the magnetic attraction force between the stationary core 20 and the moving core 22 disappears. In the present operation, the moving core 22 and the needle 40 integrally move to the opposite side of the stationary core 20 by being exerted with the biasing force of the first spring 26. Consequently, the seal portion 42 of the needle 40 is again seated to the valve seat 32 to be in the closed state. Thus, fuel injection from the nozzle holes 34 is terminated.

Next, a manufacturing process of the injector 1 is described. First, a manufacturing method for the pipe member 10 including the pipe 11 and the housing 12 is described. In present embodiment, the pipe member 10 is produced by using the metal injection molding (MIM) method. More specifically, a magnetic powder material and a binder material are uniformly mixed so as to obtain slurry 100 for producing the pipe member 10. The magnetic powder material is, for example, electromagnetic stainless steel powder. As shown in FIG. 3, the obtained slurry 100 is poured into a cavity 84, which is defined among molding dies 81, 82, 83 in a predetermined shape. Thereafter, the molding dies 81, 82, 83 are removed and the molded product is obtained.

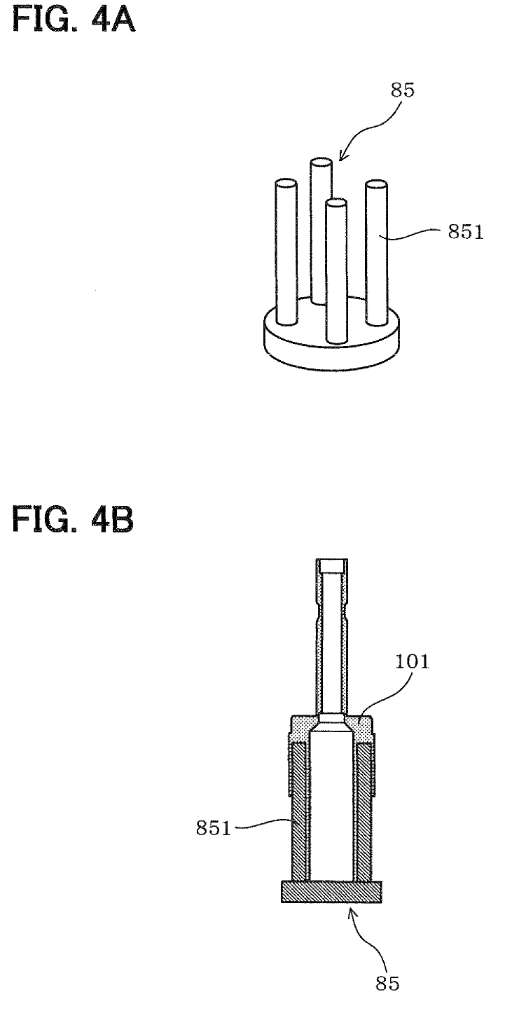

As shown in FIG. 4B, the obtained molded product 101 is held by a jig 85 so as to restrict the obtained molded product 101 from deforming. As shown in FIG. 4B, the jig 85 has holding portions 851 each projected therefrom. Referring to FIG. 4B, the molded product 101 has a space, which is configured to accommodate the coil 51. The holding portions 851 are inserted into the space of the molded product 101, whereby the molded product 101 is supported by the jig 85. Thereafter, the molded product 101, which is supported by the jig 851 is heated and degreased in a vacuum condition at about 500° C. Thus, the binder is removed from the molded product 101. Subsequently, the molded product 101 is sintered in a vacuum condition at about 1250° C. Thus, the pipe member 10 is obtained.

Subsequently, the valve body 31 is attached to the tip end 111 of the pipe 11 of the pipe member 10. Afterwards, the moving core 22 and the needle 40 are accommodated inside the pipe 11. The moving core 22 is integrated with the needle 40 by, for example, press-fitting or welding in advance.

And subsequently, the coil assembly 50, which includes the coil 51, the mold element 52, and the electrical connector 53, is attached to the pipe member 10. At the time, the coil 51 of the coil assembly 50 is inserted into the space between the pipe 11 and the housing 12 of the pipe member 10. Thus, the coil assembly 50 is held between the pipe 11 and the housing 12. And subsequently, the cover 60 is attached to surround the rear end of the coil 51.

And subsequently, the stationary core 20 is press-fitted from the rear end side of the pipe 11. The first spring 26 is inserted into the inner circumferential periphery of the stationary core 20, and subsequently the adjusting pipe 28 is press-fitted to the inner circumferential periphery of the stationary core 20. Further, the external connector 19 is press-fitted to the rear end 112 of the pipe 11, and the filter member 18 is attached to the inside of the external connector 19. Thus, the manufacturing of the injector 1 is completed.

Next, an operation effect of the injector (fuel injection valve) 1 according to the present embodiment is described. In the injector 1 according to the present embodiment, the pipe 11 and the housing 12 are integrated into the one component (single component). Therefore, the number of components can be reduced, compared with the structure in which the pipe 11 and the housing 12 are constructed of two or more components. Thus, the structure of the injector 1 can be simplified, and therefore productivity and quality of the injector 1 can be enhanced.

More specifically, a manufacturing process such as aligning of the pipe 11 relative to the housing 12 in the axial direction and fixing of the pipe 11 to the housing 12 by welding or the like can be omitted, dissimilarly to the conventional structure in which the pipe is a separate component from the housing. Therefore, man power for manufacturing the injector can be reduced, so that productivity of the injector can be enhanced. Further, a joined portion between the pipe 11 and the housing 12 can be reduced. As a whole, a joint portion of components can be reduced. Thus, strength of the injector 1 can be enhanced, compared with the conventional structure, and therefore reliability of the injector 1 can be further enhanced.

Furthermore, the pipe 11 and the housing 12 can be enhanced in coaxiality and dimensional accuracy by integrating the pipe 11 with the housing 12 into the one component. Therefore, dimensional control at the time of mounting the injector 1 to the engine or the like can be facilitated, and thereby mountability of the injector 1 can be enhanced. Further, in the present structure, accuracy of the location of the injector 1 when mounted to the engine can be enhanced, and hence product quality such as the fuel injection angle of the injector 1 can be enhanced.

Further, the pipe 11 and the housing 12 are integrally formed to be the pipe member 10 by the metal injection molding (MIM) method. Therefore, flexibility of the shape of the pipe member 10 is enhanced. Thus, the integrated one component with high dimensional accuracy and high quality can be obtained, even when the one component is complicated in shape. Application of the MIM method is significantly effective, in particular, when the pipe 11 and the housing 12 configure a double-pipe structure similarly to the present embodiment.

In addition, loss in magnetism can be reduced by using the MIM method. Conventionally, generated magnetism is reduced in a joined portion, in which the pipe is fixed to the housing by press-fitting, welding or the like, and the reduction in magnetism is caused by a gap therebetween caused by welding defect such as blow hole or related to low dimensional accuracy of the components. On the contrary, in the present embodiment, the joint portion is omitted from the magnetic circuit and the gap caused in the joint portion is eliminated by integrally forming the pipe 11 and the housing 12 by the MIM method. In the present structure, loss in magnetism can be reduced between the pipe 11 and the housing 12. Consequently, magnetic attraction force between the stationary core 20 and the moving core 22 can be enhanced.

As described above, according to the present embodiment, productivity and quality of the injector (fuel injection valve) can be enhanced with a simple structure.

### Second Embodiment

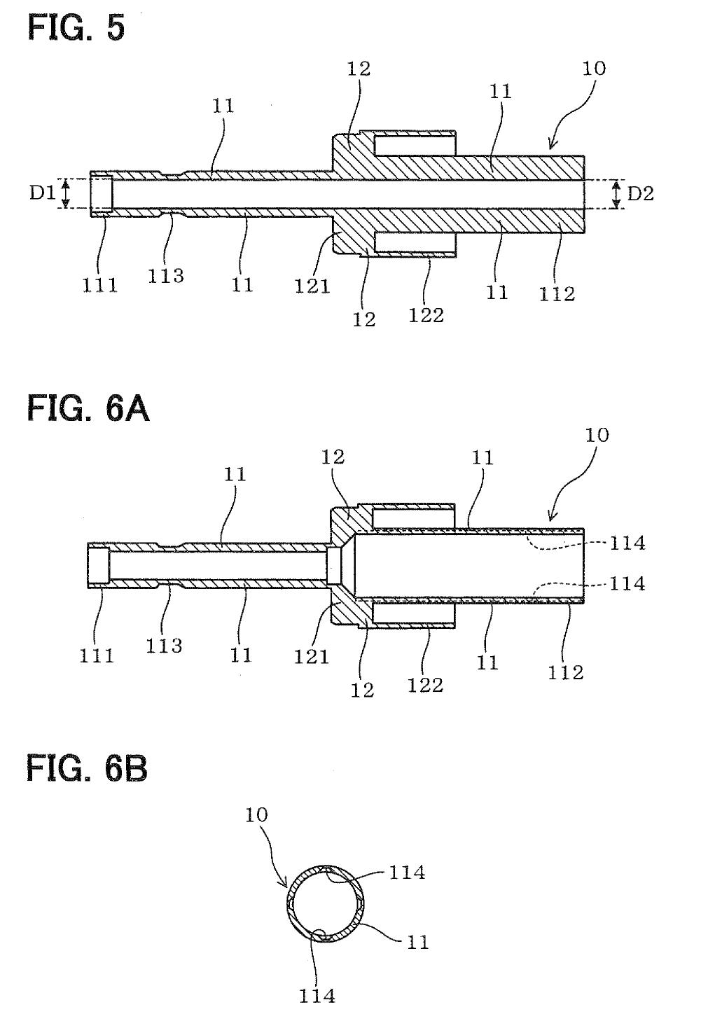

The present embodiment is a modification of the pipe member 10 of the injector (fuel injection valve) 1 according to the first embodiment. FIG. 5 depicts the pipe member 10 in which the inner diameter D1 of the tip end of the pipe 11 is the same as the inner diameter D2 of the rear-side portion of the pipe 11. In this structure, the inner diameter of the pipe 11 is substantially the same, i.e., constant in the axial direction. In the present embodiment, the inner diameters D1, D2 satisfy D1, D2=φ4.7 mm. FIG. 5 depicts only the pipe member 10.

In the present structure, manufacturing of the pipe member 10 is facilitated by determining the inner diameter of the tip end of the pipe 11 to be substantially the same as the inner diameter of the rear-side portion of the pipe 11. Here, in the present structure, an area for attracting the moving core 22 may be reduced, since the inner diameter of the tip end of the pipe 11 is determined to be substantially the same as the inner diameter of the rear-side portion of the pipe 11. Accordingly, the present structure shown in FIG. 5 may be hard to be applied to a direct-injection gasoline engine operated at high pressure such as 10 to 30 MPa. However, the present structure shown in FIG. 5 may be applied to a premix gasoline engine operated at low pressure such as 0.5 MPa.

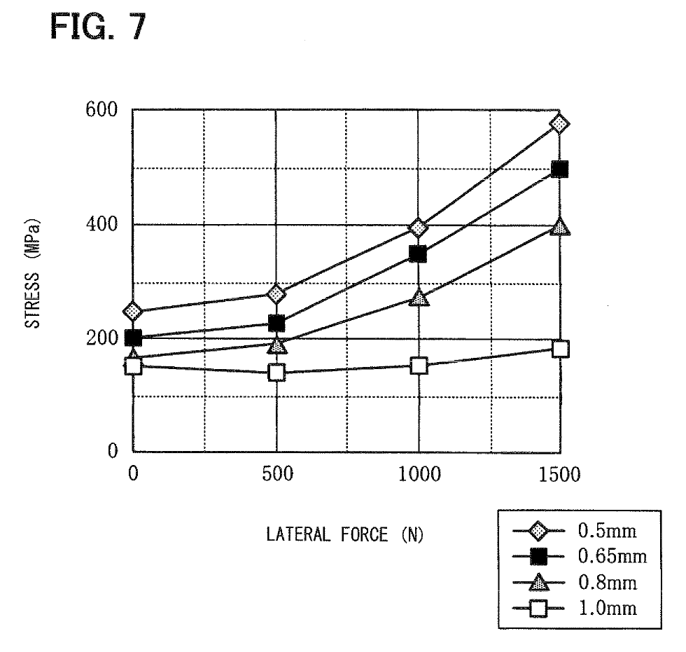

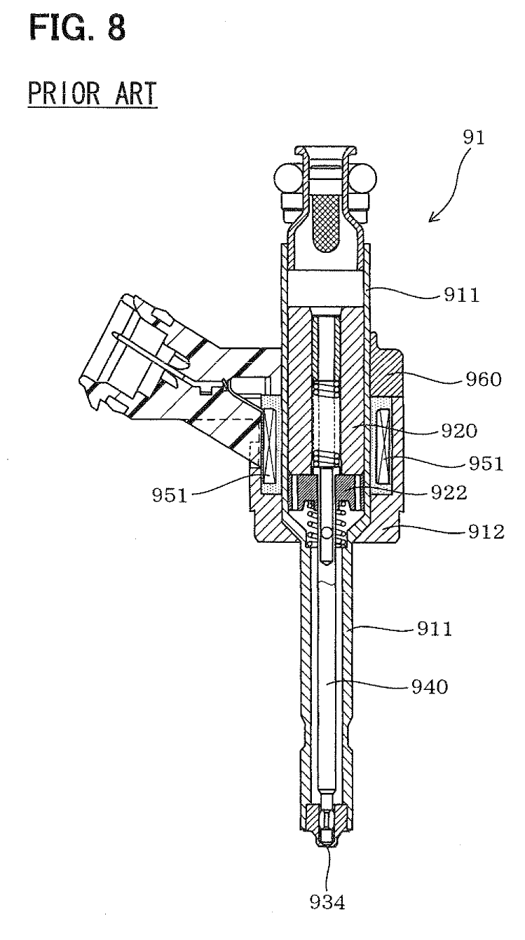

Each of FIGS. 6A, 6B shows a structure in which grooves 114 are provided to the rear-side portion of the pipe 11 of the pipe member 10. Each of the grooves 114 extends in the inner circumferential periphery of the pipe 11 substantially in the axial direction. Each groove 114 extends to a tip end portion beyond the accommodating portion configured to accommodate the moving core 22 (FIG. 1). FIG. 6 depicts only the pipe member 10.

In the present structure shown in FIGS. 6A, 6B, each groove 114 of the pipe 11 is located around the outer circumferential periphery of the moving core 22. Therefore, the moving core 22 and the pipe 11 therebetween define gaps, which is configured to function similarly to the through hole 221 (FIG. 1) of the moving core 22. More specifically, the gaps between the moving core 22 and the pipe 11 are configured to therethrough flow fuel so as to restrict the moving core 22 from sticking to the stationary core 20. In the present structure, the moving core 22 need not be provided with the through hole 221. Therefore, a manufacturing process of the through hole 221 can be omitted, and hence productivity of the injector can be enhanced. Furthermore, the pipe member 10 having such a complicated structure can be easily manufactured by the MIM method.

### Third Embodiment

In the present embodiment, estimation results of strength of the injector (fuel injection valve) are described. Here, values of strength of injectors having different thicknesses t2 (FIG. 2) of the pipe are obtained by conducting a simulation. Each of the injectors has substantially the same structure as that in the first embodiment, excluding the thickness t2 of the pipe. In the present simulation, the thickness t2 of the pipe is determined to 0.5 mm, 0.65 mm, 0.8 mm, or 1.0 mm. In the present simulation, stress caused in the pipe portion is obtained on the premise where lateral force is applied in the radial direction to a portion at 5 mm from the end surface of the rear end of the pipe of the pipe member.

FIG. 7 depicts a relationship between the lateral force (N) and the stress (MPa) according to the result of the simulation. It is obvious from FIG. 7, when the thickness t2 is less than 1.0 mm and equal to one of 0.5 mm, 0.65 mm, and 0.8 mm, the stress increases as the lateral force increases. On the other side, when the thickness t2 is 1.0 mm, the stress is substantially constant regardless of increase in the lateral force. Therefore, the thickness t2 of the pipe 11 is preferably greater than or equal to 1.0 mm.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

The above structures of the embodiments can be combined as appropriate. Various modifications and alternations may be diversely made to the above embodiments without departing from the spirit of the present invention.

What is claimed is:

1. A fuel injection valve comprising:
a pipe being substantially in a cylindrical shape;
a coil located radially outside of the pipe and configured to generate a magnetic field when being energized;
a stationary core located radially inside of the pipe;
a moving core located radially inside of the pipe and opposed to the stationary core, the moving core configured to be attracted to the stationary core by magnetic attractive force generated between the moving core and the stationary core;
a valve element movable together with the moving core in an axial direction and configured to open and close a nozzle hole for injecting fuel;
a housing surrounding both an outer circumferential periphery of the coil and one end of the coil, which is at one end side in the axial direction; and
a cover surrounding an other end of the coil, which is at an other end side in the axial direction,
wherein the pipe and the housing are integrally formed and a single component.

2. The fuel injection valve according to claim 1, wherein the pipe and the housing are integrally formed by metal injection molding.

3. The fuel injection valve according to claim 1,
wherein the pipe has a valve-accommodating portion, which accommodates the valve element,
the valve-accommodating portion has an inner diameter D1,
the pipe has a moving-core-accommodating portion, which accommodates the moving core,
the moving-core-accommodating portion has an inner diameter D2, and
the inner diameters D1, D2 satisfy D1≦D2.

4. The fuel injection valve according to claim 1,
wherein the valve-accommodating portion has a fitting portion, which is dented in a radial direction and configured to be fitted with an annular sealing member,
the valve-accommodating portion has an intermediate portion at a rear side of the fitting portion,
the intermediate portion has a thickness t1,
the fitting portion has a thickness t3, and
the thicknesses t1, t3 satisfy t1≧t3.

5. The fuel injection valve according to claim 1, wherein the moving-core-accommodating portion has a thickness t2, which is greater than or equal to 1 mm.

6. The fuel injection valve according to claim 1, wherein each of the pipe, the stationary core, the moving core, the housing, and the cover are formed of a magnetic material.

7. The fuel injection valve according to claim 6,
wherein the housing, the pipe, the moving core, the stationary core, and the cover define a magnetic circuit, and
the magnetic circuit therethrough flows magnetic flux, and the moving core and the stationary core therebetween generate the magnetic attraction force, in response to energization of the coil and generation of the magnetic field.

8. The fuel injection valve according to claim 1,
wherein the pipe has a valve-accommodating portion, which accommodates the valve element,
the valve-accommodating portion has an inner diameter D1,
the pipe has a moving-core-accommodating portion, which accommodates the moving core,
the moving-core-accommodating portion has an inner diameter D2, and
the inner diameters D1, D2 substantially satisfy D1=D2.

9. The fuel injection valve according to claim 1, wherein the pipe and the housing are substantially coaxial with each other to define a double-pipe structure.

10. The fuel injection valve according claims 1,
wherein the pipe and the housing are substantially coaxial with each other, and
the pipe and the housing are integrally formed with a bottom portion to define a bottomed double-pipe structure.
